(19) United States
(12) Patent Application Publication
(10) Pub. No.: US 2024/0081398 A1
(43) Pub. Date: Mar. 14, 2024

(54) Connecting structure for an electronic cigarette

(71) Applicant: CHARLES CHING LAR WONG, PASADENA, CA (US)

(72) Inventor: CHARLES CHING LAR WONG, PASADENA, CA (US)

(21) Appl. No.: 17/981,492

(22) Filed: Nov. 7, 2022

(30) Foreign Application Priority Data
Sep. 13, 2022 (CN) 202222415336.7

(51) Int. Cl. A24F 40/40; A24F 7/02; F16B 7/04

(52) U.S. Cl. CPC A24F 40/40; A24F 7/02; F16B 7/0413

(57) ABSTRACT

A connecting structure for an electronic cigarette, having a connector; one end of the connector is connected to an atomizer; another end of the connector is connected to a mouthpiece; an outer side surface of the connector is provided with rotation limiting grooves; an inner side surface of the mouthpiece is provided with rotation limiting blocks; fastening portions are provided on the connector adjacent to the rotation limiting grooves; the rotation limiting blocks are positioned inside the rotation limiting grooves, and the fastening portions fasten the rotation limiting blocks.

### BACKGROUND OF THE INVENTION

The present invention relates to a connecting structure for an electronic cigarette.

An electronic cigarette in the prior art generally comprises an atomizer and a mouthpiece separable from each other. The atomizer and the mouthpiece are connected to each other through a connecting structure. In the prior art, the connecting structure and the mouthpiece are usually connected to each other by glues. However, the above described connections have the following problems:

1. Glues can be easily melted under high temperature. Accordingly, the mouthpiece and the connecting structure can be easily disassembled from each other. Also, melting glues produce bad odor that leads to bad user's experience and health hazards.

2. Assembling efficiency is low and defective rate of the end product is high due to complicated procedure of applying glues.

### BRIEF SUMMARY OF THE INVENTION

It is an object of the present invention to solve the technical problems in the prior art by providing a connecting structure for an electronic cigarette. To achieve said object of the present invention, the following technical solutions are provided:

A connecting structure for an electronic cigarette, comprising a connector; one end of the connector is connected to an atomizer; another end of the connector is connected to a mouthpiece; an outer side surface of the connector is provided with rotation limiting grooves; an inner side surface of the mouthpiece is provided with rotation limiting blocks; fastening portions are provided on the connector adjacent to the rotation limiting grooves respectively; the rotation limiting blocks are positioned inside the rotation limiting grooves respectively, and the fastening portions fasten the rotation limiting blocks respectively.

Further, said end of the connector connected to the atomizer is provided with a seal.

Further, the seal comprises an inner sealing ring and an outer sealing ring; a buckling portion is formed between the inner sealing ring and the outer sealing ring; the connector buckles to the buckling portion.

Further, the connector is provided with an annular flange; an inner side of the outer sealing ring is provided with an annular position limiting groove; the annular flange is positioned in the annular position limiting groove.

The present invention has the following beneficial effects: According to the present invention, the outer side surface of the connector is provided with rotation limiting grooves, the inner side surface of the mouthpiece is provided with rotation limiting blocks; when the mouthpiece sleeves onto the connector, the rotation limiting blocks are positioned inside the rotation limiting grooves such that rotation of the connector with respect to the mouthpiece will be limited; further, since the rotation limiting blocks are fastened by the fastening portions, the mouthpiece is prevented from disengaging with the connector. In the present invention, the connector and the mouthpiece are connected by fastening. Compared with using glues in the prior art, assembly of the connector and the mouthpiece is convenient and efficient, the defective rate of the end product is low, and the end product can be safely used.

### BRIEF DESCRIPTION OF THE DRAWINGS

In order to describe the technical solutions of the present invention more clearly, the drawings required to describe the embodiments are briefly introduced below. Apparently, the drawings described below illustrate only some of the possible embodiments of the present invention. A person skilled in the art, without any additional inventive input, may also obtain other drawings based on the drawings described below.

FIG. 1 is a schematic structural view of the electronic cigarette according to the present invention.

FIG. 2 is a schematic structural view showing the mouthpiece, the connector and the seal of the present invention.

FIG. 3 is a schematic diagram showing connection between the mouthpiece and the connector according to the present invention.

FIG. 4 is a schematic diagram showing the seal and the connector of the present invention disconnected from each other.

FIG. 5 is a schematic diagram showing connection between the seal and the connector of the present invention connected to each other.

It should be noted that, the drawings are not necessarily drawn in scale. The drawings are only drawn illustratively so as not to undermine the comprehension by the reader.

### DETAILED DESCRIPTION OF THE INVENTION

The technical solutions provided according to the embodiments of the present invention will be further described clearly and comprehensively with reference to the accompanying drawings. Apparently, the described embodiments are only some but not all of the possible embodiments of the present invention. Any other embodiments obtainable based on the disclosed embodiments herein by a person skilled in the art without any inventive input should also fall within the scope of the protection of the present invention.

In the description, it should be understood that orientations or positional relationships indicated by the terms “upper”, “lower”, “left”, “right”, “front”, “rear”, “top”, “bottom”, “inner”, “outer”, “within”, “vertical”, “horizontal” and the like are orientations or positional relationships as shown in the drawings, and are only for the purpose of facilitating the description of the present invention instead of indicating or implying that devices, elements or constituents being indicated must have particular orientations, or be constructed and operated in the particular orientations.

Also, some of the terms mentioned above may contain other meanings apart from indicating orientations or positional relationships. For example, the term “upper” in some contexts may refer to a certain kind of interrelationship or connection. A person skilled in the art can understand the meaning of the terms in the description according to specific contexts.

Further, terms such as “mount”, “configure”, “comprise”, “connect”, “link” and the like should be interpreted in a broad sense. For example, it may be a fixed connection, a detachable connection or integration; may be a mechanical connection or an electric connection; or may be a direct connection, an indirect connection by means of an intermediate, an internal interconnection of two elements or an interaction of two elements. For those of ordinary skill in the art, the specific meanings of the above terms in the present invention can be understood according to specific contexts.

In addition, the terms “first” and “second” are only used for the purpose of differentiating different devices, components or constituents (wherein the types and structures of said different devices, components or constituents may be the same or different), and may not be understood as indicating or implying the relative importance or quantity of the devices, components or constituents indicated. The term “plurality” refers to two or more, unless otherwise specified.

It should also be understood that, the terms in the description are only used for the purpose of describing specific embodiments, but they are not intended to limit the present invention. As used in the description and claims of the present invention, the singular form implied by the terms “a”, “one” and “this” may imply plural form as well, unless otherwise specified according to the contexts.

Moreover, the term “and/or” used in the description and claims may imply any one of the various items linked by the term, any possible combination of the various items, all possible combinations of the various items, and all of the above situations.

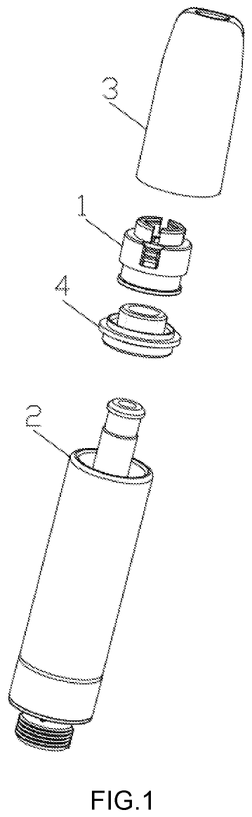

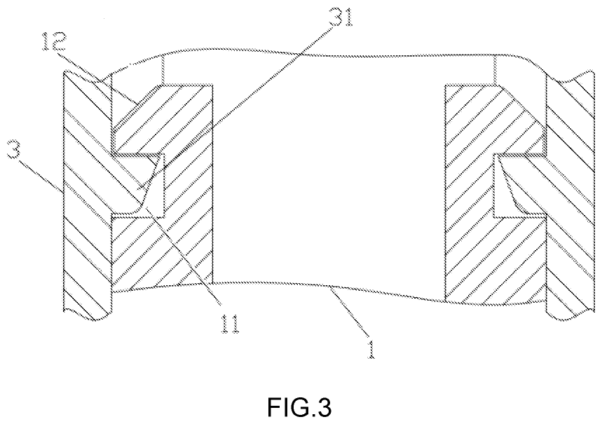

As shown in FIG. 1 to FIG. 3, the present invention provides a connecting structure for an electronic cigarette, comprising a connector 1; one end of the connector 1 is connected to an atomizer 2; another end of the connector 1 is connected to a mouthpiece 3; an outer side surface of the connector 1 is provided with rotation limiting grooves 11; an inner side surface of the mouthpiece 3 is provided with rotation limiting blocks 31; fastening portions 12 are provided on the connector 1 adjacent to the rotation limiting grooves 11 respectively; the rotation limiting blocks 31 are positioned inside the rotation limiting grooves 11 respectively, and the fastening portions 12 fasten the rotation limiting blocks 31 respectively.

According to the present invention, the outer side surface of the connector 1 is provided with rotation limiting grooves 11, the inner side surface of the mouthpiece 3 is provided with rotation limiting blocks 31; when the mouthpiece 3 sleeves onto the connector 1, the rotation limiting blocks 31 are positioned inside the rotation limiting grooves 11 such that rotation of the connector 1 with respect to the mouthpiece 3 will be limited; further, since the rotation limiting blocks 31 are fastened by the fastening portions 12, the mouthpiece 3 is prevented from disengaging with the connector 1. In the present invention, the connector 1 and the mouthpiece 3 are connected by fastening. Compared with using glues in the prior art, assembly of the connector and the mouthpiece is convenient and efficient, the defective rate of the end product is low, and the end product can be safely used.

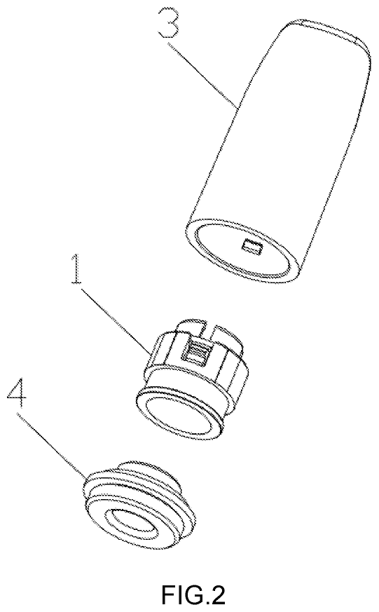

According to further technical solutions provided by the present invention as shown in FIGS. 2, 4 and 5, said end of the connector 1 connected to the atomizer 2 is provided with a seal 4.

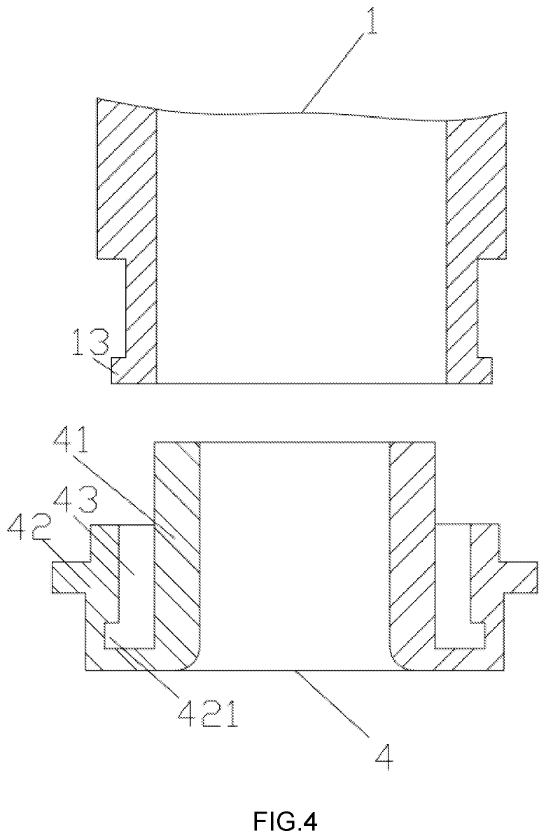

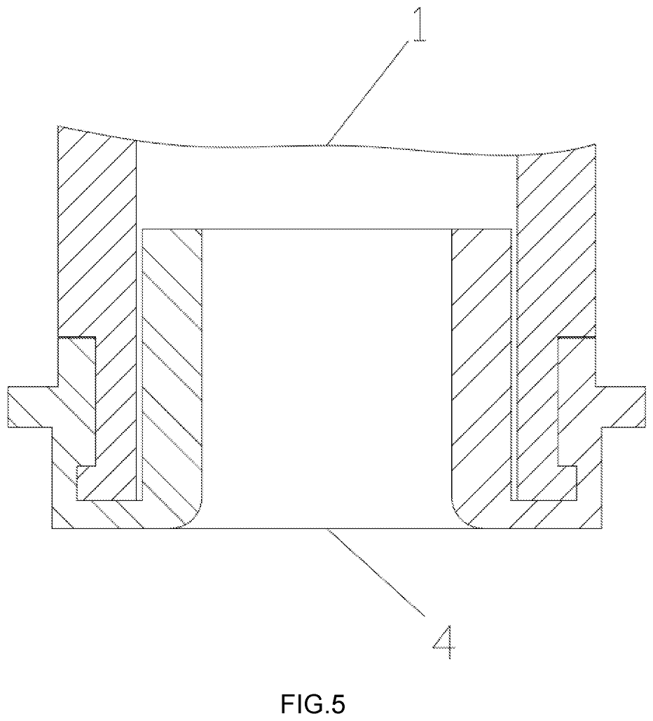

According to further technical solutions provided by the present invention as shown in FIGS. 4 and 5, the seal 4 comprises an inner sealing ring 41 and an outer sealing ring 42; a buckling portion 43 is formed between the inner sealing ring 41 and the outer sealing ring 42; the connector 1 buckles to the buckling portion 43. The seal 4 is tightly fitted with the connector 1 to provide great sealing effect.

According to further technical solutions provided by the present invention as shown in FIGS. 4 and 5, the connector 1 is provided with an annular flange 13; an inner side of the outer sealing ring 42 is provided with an annular position limiting groove 421; the annular flange 13 is positioned in the annular position limiting groove 421. Such a position limiting feature prevents easy disengagement between the connector 1 and the seal 4 and thus guarantees good sealing effect.

It should also be noted that, different embodiments of the present invention and the different features mentioned in the different embodiments may be combined to form other new embodiments not described herein so long as the combined embodiments and/or features are compatible.

The above description only describes the preferred embodiments of the present invention. The description is not intended to limit the present invention in terms of the form of the present invention. The scope of the protection of the present invention should be interpreted according to the claims. Although the present invention is disclosed above according to some preferred embodiments which are not intended to limit the present invention, any person skilled in the art, without departing from the scope of the present invention, may obtain other embodiments of equivalent technical effects by making slight changes or modifications based on the above disclosure. Any other technical solutions obtained by any simple changes, modifications and alternative configurations of the disclosed embodiments according to the essence of the present invention without departing from the technical scheme of the present invention should also fall within the scope of present invention.

What is claimed is:

1. A connecting structure, adapted for use in an electronic cigarette; wherein the connecting structure comprises a connector; one end of the connector is adapted to be connected to an atomizer; another end of the connector is connected to a mouthpiece; an outer side surface of the connector is provided with rotation limiting grooves; an inner side surface of the mouthpiece is provided with rotation limiting blocks; fastening portions are provided on the connector adjacent to the rotation limiting grooves respectively; the rotation limiting blocks are positioned inside the rotation limiting grooves respectively, and the fastening portions fasten the rotation limiting blocks respectively.

2. The connecting structure of claim 1, wherein said end of the connector adapted to be connected to the atomizer is provided with a seal.

3. The connecting structure of claim 2, wherein the seal comprises an inner sealing ring and an outer sealing ring; a buckling portion is formed between the inner sealing ring and the outer sealing ring; the connector buckles to the buckling portion.

4. The connecting structure of claim 3, wherein the connector is provided with an annular flange; an inner side of the outer sealing ring is provided with an annular position limiting groove; the annular flange is positioned in the annular position limiting groove.
